(19) United States
(12) Patent Application Publication
(10) Pub. No.: US 2023/0369873 A1
(43) Pub. Date: Nov. 16, 2023

(54) BIDIRECTIONAL CHARGING CIRCUIT, APPARATUS, AND CONTROL METHOD OF ELECTRICITY STORAGE DEVICE

(71) Applicant: ALLPOWERS INDUSTRIAL INTERNATIONAL CO., LTD., Guangzhou, Guangdong (CN)

(72) Inventor: Xiaojun Zhong, Guangzhou, Guangdong (CN)

(21) Appl. No.: 18/029,299

(22) PCT Filed: Sep. 16, 2021
(86) PCT No.: PCT/CN2021/118723

§ 371 Date: Mar. 29, 2023

(30) Foreign Application Priority Data
Dec. 30, 2020 (CN) 202011610967.3

(51) Int. Cl. H02J 7/00; H02J 7/06

(52) U.S. Cl. CPC H02J 7/0068; H02J 7/0063; H02J 7/06

(57) ABSTRACT

A bidirectional charging circuit of an electricity storage device includes a step-up and step-down switching module, an inversion and rectification module, a switch module, and a main control module, where the step-up and step-down switching module is provided with a battery connection terminal connected to a battery pack, the switch module is provided with a load connection terminal connected to an electrical appliance and a first mains supply connection terminal, and the main control module is provided with a second mains supply connection terminal; the step-up and step-down switching module is connected to the inversion and rectification module, and the inversion and rectification module is connected to the switch module; and the main control module is separately connected to the step-up and step-down switching module, the inversion and rectification module, and the switch module. A bidirectional charging circuit, apparatus, and control method of an electricity storage device are provided.

### TECHNICAL FIELD

The present disclosure relates to the technical field of storage batteries, and in particular, to a bidirectional charging circuit, apparatus, and control method of an electricity storage device.

### BACKGROUND

A storage battery is charged by a charging module. Electric energy output by the storage battery is converted by an inversion module into voltages of different specifications to supply power to a power receiving device. However, existing storage batteries cannot be charged while being discharged. In an existing technical solution, a charging circuit and a discharging circuit are independent of each other, and independent charging and discharging modules occupy a large amount of physical space. As a result, a bidirectional charging circuit with the charging module and the discharging module is large and complex, and there are many elements in the circuit, resulting in a large overall volume of the circuit. In addition, the charging circuit and the discharging circuit of the existing bidirectional charging circuit are used separately. The charging module is used during charging and the discharging module is used during discharging. It is generally prohibited to perform the discharging outward during the charging, otherwise completion time of the charging is greatly prolonged even if the discharging can be performed.

### SUMMARY

To resolve the above technical problem, the present disclosure provides a bidirectional charging circuit, apparatus, and control method of an electricity storage device, so as to provide a bidirectional charging solution for charging and discharging. The present disclosure adopts following technical solutions:

An embodiment of the present disclosure provides a bidirectional charging circuit of an electricity storage device, including a step-up and step-down switching module, an inversion and rectification module, a switch module, and a main control module, where
the step-up and step-down switching module is provided with a battery connection terminal connected to a battery pack, the switch module is provided with a load connection terminal connected to an electrical appliance and a first mains supply connection terminal, and the main control module is provided with a second mains supply connection terminal;
the step-up and step-down switching module is connected to the inversion and rectification module, and the inversion and rectification module is connected to the switch module; and
the main control module is separately connected to the step-up and step-down switching module, the inversion and rectification module, and the switch module.

As a preferred solution, the inversion and rectification module includes an inversion controller and a first full-bridge circuit composed of a field effect transistor and its parasitic diode, and switch control terminals of field effect transistors of the first full-bridge circuit are all connected to the inversion controller.

As a preferred solution, the step-up and step-down switching module includes a step-up module, a step-down module, and a transformer;
the step-up module includes a step-up controller and a second full-bridge circuit composed of a field effect transistor and its parasitic diode, and switch control terminals of field effect transistors of the second full-bridge circuit are all connected to the step-up controller;
the step-down module includes a step-down controller and a third full-bridge circuit composed of a field effect transistor and its parasitic diode, and switch control terminals of field effect transistors of the third full-bridge circuit are all connected to the step-down controller; and

one terminal of the transformer is connected to the second full-bridge circuit, and the other terminal of the transformer is connected to the third full-bridge circuit.

As a preferred solution, any of the first full-bridge circuit, the second full-bridge circuit, or the third full-bridge circuit includes a first field effect transistor, a second field effect transistor, a third field effect transistor, and a fourth field effect transistor that are specifically connected in a following manner:
a drain of the first field effect transistor is connected to a drain of the second field effect transistor, and a source of the third field effect transistor is connected to a source of the fourth field effect transistor; and
a source of the first field effect transistor is connected to a drain of the third field effect transistor, and a source of the second field effect transistor is connected to a drain of the fourth field effect transistor.

As a preferred solution, the first field effect transistor, the second field effect transistor, the third field effect transistor, and the fourth field effect transistor are all N-channel metal oxide semiconductor (MOS) transistors.

As a preferred solution, the step-up and step-down switching module further includes a capacitor for filtering, and the capacitor is connected in parallel to the second full-bridge circuit or the third full-bridge circuit.

To resolve the same technical problem, an embodiment of the present disclosure provides a bidirectional charging apparatus of an electricity storage device, including a battery pack and the above bidirectional charging circuit of an electricity storage device, and the battery pack is connected to a battery connection terminal of the bidirectional charging circuit of the electricity storage device.

In addition, an embodiment of the present disclosure provides a bidirectional charging control method of an electricity storage device, applied to the above bidirectional charging circuit of an electricity storage device, or the above bidirectional charging apparatus of an electricity storage device, where
the main control module is configured to:
when a connected mains supply is detected by the second mains supply connection terminal, control the switch module to turn on the circuit, such that the mains supply is connected to the electrical appliance by the load connection terminal and connected to the battery pack after passing through the switch module, the inversion and rectification module, and the step-up and step-down switching module in turn;
control the inversion and rectification module to switch to a rectification function, such that the mains supply is converted into a direct current after being rectified; and
control the step-up and step-down switching module to switch to a step-down function, so as to convert a high voltage of the mains supply into a low voltage.

As a preferred solution, the main control module is further configured to:
when the connected mains supply is not detected, control the switch module to turn on the circuit, such that electric energy output by the battery pack is transmitted to the electrical appliance after passing through the step-up and step-down switching module, the inversion and rectification module, and the switch module in turn;
control the step-up and step-down switching module to switch to a step-up function, so as to convert a low voltage output by the battery pack into a high voltage; and
control the inversion and rectification module to switch to an inversion function, so as to convert a direct current output by the battery pack into an alternating current.

As a preferred solution, the main control module is further configured to:
control the switch module to turn off the circuit to stop supplying power to the electrical appliance.

Compared with the prior art, the embodiments of the present disclosure have following beneficial effects:

The present disclosure provides the bidirectional charging circuit, apparatus, and control method of an electricity storage device. In the circuit in the present disclosure, the step-up and step-down switching module supports switching between the step-up function and the step-down function. The step-up and step-down switching module switches to the step-up function, to increase an output voltage of the battery pack, and enable the battery pack to perform discharging outward by inverting the direct current into the alternating current by the inversion and rectification module, thereby realizing a discharging function. The step-up and step-down switching module switches to the step-down function, such that the alternating current input into the mains supply is converted into the direct current by the inversion and rectification module, and then an input voltage is stepped down to a voltage that meets a specification of the battery pack, thereby charging the battery pack. A charging current needs to pass through the inversion and rectification module before reaching the battery pack or a discharging current needs to pass through the inversion and rectification module before being output to the electrical appliance, in other words, the inversion and rectification module is shared for both a charging function and the discharging function. Therefore, compared with a solution in which the charging module and the discharging module are separately configured for a rectification circuit and an inversion circuit, the solutions in the present disclosure realize a bidirectional charging and discharging technology, and can effectively simplify the circuit, save space occupied by the charging module and the discharging module, and reduce a scale of the overall circuit.

### BRIEF DESCRIPTION OF THE DRAWINGS

FIG. 1 is a structural diagram of an exemplary embodiment of a bidirectional charging circuit of an electricity storage device according to an embodiment of the present disclosure;

FIG. 2 is a circuit diagram of a preferred embodiment of a bidirectional charging circuit of an electricity storage device according to an embodiment of the present disclosure; and

FIG. 3 is a flowchart showing steps of a bidirectional charging control method of an electricity storage device according to an embodiment of the present disclosure.

### DETAILED DESCRIPTION

The technical solutions of the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

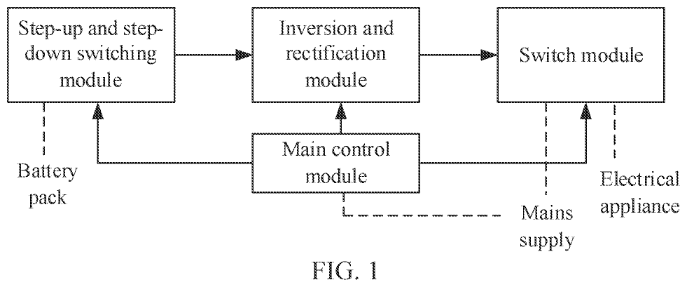

As shown in FIG. 1, in an exemplary embodiment of the present disclosure, a bidirectional charging circuit of an electricity storage device includes a step-up and step-down switching module, an inversion and rectification module, a switch module, and a main control module.

The step-up and step-down switching module is provided with a battery connection terminal connected to a battery pack, the switch module is provided with a load connection terminal connected to an electrical appliance and a first mains supply connection terminal, and the main control module is provided with a second mains supply connection terminal.

The step-up and step-down switching module is connected to the inversion and rectification module, and the inversion and rectification module is connected to the switch module.

The main control module is separately connected to the step-up and step-down switching module, the inversion and rectification module, and the switch module.

It can be understood that the step-up and step-down switching module includes a step-up circuit for stepping up a voltage and a step-down circuit for stepping down the voltage.

In this embodiment, the inversion and rectification module includes an inversion controller and a first full-bridge circuit composed of a field effect transistor and its parasitic diode, and switch control terminals of field effect transistors of the first full-bridge circuit are all connected to the inversion controller.

Preferably, in the full-bridge circuit composed of the field effect transistor, all field effect transistors are MOS transistors.

In an implementation of this embodiment, the step-up and step-down switching module includes the step-up circuit, the step-down circuit, and a switching switch;
both the step-up circuit and the step-down circuit are connected to the switching switch; and
when the switching switch receives a step-up instruction from the main control module, a connection to the step-up circuit is closed and a connection to the step-down circuit is interrupted; or
when the switching switch receives a step-down instruction from the main control module, a connection to the step-down circuit is closed and a connection to the step-up circuit is interrupted.

In another implementation of this embodiment, the step-up and step-down switching module includes a step-up module, a step-down module, and a transformer;
the step-up module includes a step-up controller and a second full-bridge circuit composed of a field effect transistor and its parasitic diode, and switch control terminals of field effect transistors of the second full-bridge circuit are all connected to the step-up controller;
the step-down module includes a step-down controller and a third full-bridge circuit composed of a field effect transistor and its parasitic diode, and switch control terminals of field effect transistors of the third full-bridge circuit are all connected to the step-down controller; and
one terminal of the transformer is connected to the second full-bridge circuit, and the other terminal of the transformer is connected to the third full-bridge circuit.

Preferably, the step-up and step-down switching module further includes a capacitor for filtering, and the capacitor is connected in parallel to the second full-bridge circuit or the third full-bridge circuit.

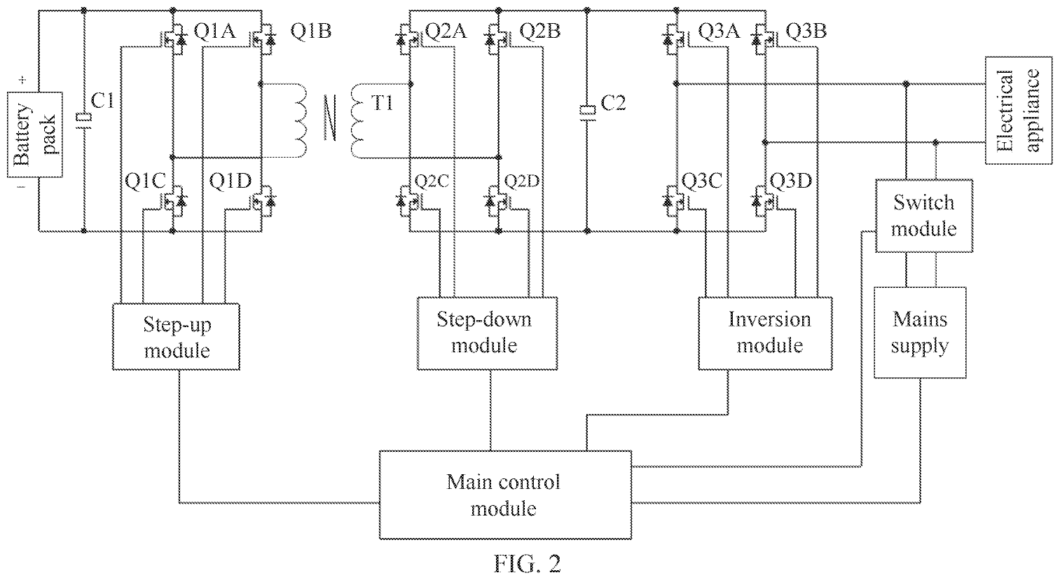

As shown in FIG. 2, specifically, in the bidirectional charging circuit of an electricity storage device,
the step-up and step-down switching module includes the step-up module, the step-down module, and the transformer; the step-up module includes the step-up controller and the second full-bridge circuit; and the step-down module includes the step-down controller and the third full-bridge circuit.

The inversion and rectification module includes the inversion controller and the first full-bridge circuit.

Specifically, any of the first full-bridge circuit, the second full-bridge circuit or the third full-bridge circuit includes a first field effect transistor, a second field effect transistor, a third field effect transistor, and a fourth field effect transistor that are specifically connected in a following manner:
a drain of the first field effect transistor is connected to a drain of the second field effect transistor, and a source of the third field effect transistor is connected to a source of the fourth field effect transistor; and
a source of the first field effect transistor is connected to a drain of the third field effect transistor, and a source of the second field effect transistor is connected to a drain of the fourth field effect transistor.

The first field effect transistor, the second field effect transistor, the third field effect transistor, and the fourth field effect transistor are all N-channel MOS transistors.

The first full-bridge circuit is composed of MOS transistors and their parasitic diodes, that is, Q3A, Q3B, Q3C and Q3D. Gates of the MOS transistors and their parasitic diodes, that is, Q3A, Q3B, Q3C and Q3D, are all connected to the inversion controller.

The inversion controller is connected to the main control module.

In the first full-bridge circuit, two pins with a same output/input function are connected to the switch module, and the other two pins with a same output/input function are connected to two terminals of a second capacitor C2.

The two pins connected to the two terminals of the second capacitor C2 in the first full-bridge circuit are also connected to two pins of the third full-bridge circuit.

The third full-bridge circuit is composed of MOS transistors and their parasitic diodes, that is, Q2A, Q2B, Q2C and Q2D. Gates of the MOS transistors and their parasitic diodes, that is, Q2A, Q2B, Q2C and Q2D, are all connected to the step-down controller.

The step-down controller is connected to the main control module.

The other two pins of the third full-bridge circuit are connected to one terminal of the transformer T1, and the other terminal of the transformer T1 is connected to two pins of the second full-bridge circuit.

The second full-bridge circuit is composed of MOS transistors and their parasitic diodes, that is, Q1A, Q1B, Q1C and Q1D. Gates of the MOS transistors and their parasitic diodes, that is, Q1A, Q1B, Q1C and Q1D, are all connected to the step-up controller.

The step-up controller is connected to the main control module.

The other two pins of the third full-bridge circuit are connected to two terminals of a first capacitor C1 and are respectively connected to positive and negative terminals of the battery pack.

In this embodiment, the step-up and step-down switching module is composed of the step-up module and the step-down module, and the step-up module and the step-down module share one transformer, which avoids occupying too much space due to use of two independent transformers for the step-up module and the step-down module. Therefore, this embodiment is conducive to simplifying the overall circuit. In addition, the overall circuit in this embodiment includes three full-bridge circuits and 12 MOS transistors, namely, Q1A to Q1D, Q2A to Q2D, and Q3A to Q3D. Parasitic diodes of the MOS transistors also form an overall bridge rectification circuit. Moreover, the inversion controller, the step-up controller, and the step-down controller all adopt a full-bridge pulse-width-modulation (PWM) control mode to control the three full-bridge circuits, respectively. When the battery pack needs to be discharged, the inversion controller, the step-up controller, and the step-down controller perform coordinated control to enable the overall circuit to act as a step-up and inversion conversion apparatus. When the battery pack needs to be charged, the inversion controller, the step-up controller, and the step-down controller perform coordinated control to enable the overall circuit to act as a rectification and step-down conversion apparatus. It can be seen that no matter where a current flows during charging or discharging of the circuit in this embodiment, the current flows through the entire circuit. Compared with a current shunting circuit, the circuit in this embodiment has higher integrity.

In an exemplary embodiment of the present disclosure, a bidirectional charging apparatus of an electricity storage device includes a battery pack and the above bidirectional charging circuit of an electricity storage device, and the battery pack is connected to a battery connection terminal of the bidirectional charging circuit of the electricity storage device.

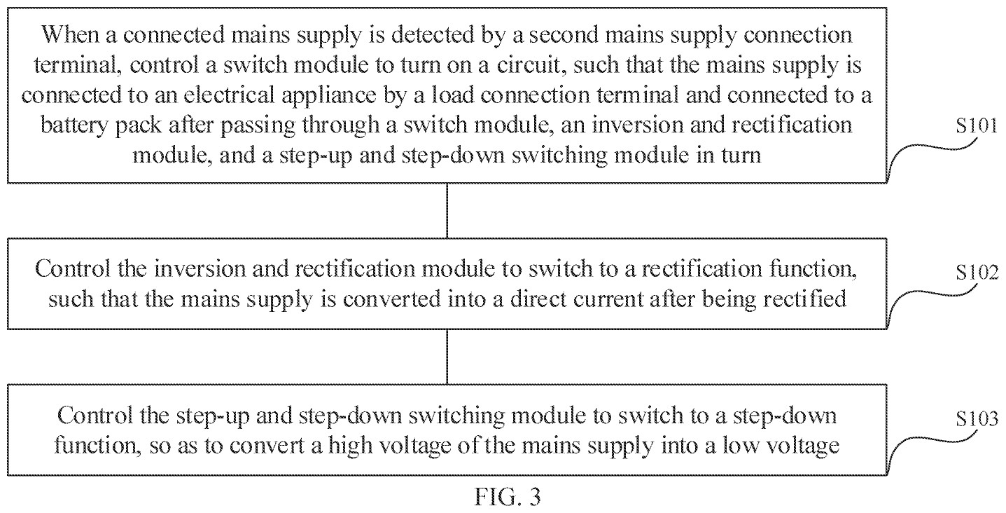

As shown in FIG. 3, in an exemplary embodiment of the present disclosure, a bidirectional charging control method of an electricity storage device is applied to the above bidirectional charging circuit of an electricity storage device, or the above bidirectional charging apparatus of an electricity storage device.

The bidirectional charging circuit of an electricity storage device includes a step-up and step-down switching module, an inversion and rectification module, a switch module, and a main control module.

The step-up and step-down switching module is provided with a battery connection terminal connected to a battery pack, the switch module is provided with a load connection terminal connected to an electrical appliance and a first mains supply connection terminal, and the main control module is provided with a second mains supply connection terminal.

The step-up and step-down switching module is connected to the inversion and rectification module, and the inversion and rectification module is connected to the switch module.

The main control module is separately connected to the step-up and step-down switching module, the inversion and rectification module, and the switch module. The main control module is configured to perform following steps:

S101: When a connected mains supply is detected by the second mains supply connection terminal, control the switch module to turn on the circuit, such that the mains supply is connected to the electrical appliance by the load connection terminal and connected to the battery pack after passing through the switch module, the inversion and rectification module, and the step-up and step-down switching module in turn.

S102: Control the inversion and rectification module to switch to a rectification function, such that the mains supply is converted into a direct current after being rectified.

S103: Control the step-up and step-down switching module to switch to a step-down function, so as to convert a high voltage of the mains supply into a low voltage.

In this embodiment, after the mains supply is connected, the main control module receives a signal indicating that the mains supply is connected, and then outputs a signal to control the switch module to turn on a switching switch, such that the mains supply can be directly transmitted to the electrical appliance for operation. After that, an inversion circuit is turned off, and then a step-up circuit is turned off. The mains supply is converted into a high-voltage direct current after being rectified, and the high-voltage direct current is converted into a low-voltage direct current after being stepped down, so as to charge the battery pack.

Specifically, in the bidirectional charging circuit of an electricity storage device in this embodiment,
the step-up and step-down switching module includes a step-up module, a step-down module, and a transformer; the step-up module includes a step-up controller and a second full-bridge circuit; and the step-down module includes a step-down controller and a third full-bridge circuit.

The inversion and rectification module includes an inversion controller and a first full-bridge circuit.

The first full-bridge circuit is composed of MOS transistors and their parasitic diodes, that is, Q3A, Q3B, Q3C and Q3D. Gates of the MOS transistors and their parasitic diodes, that is, Q3A, Q3B, Q3C and Q3D, are all connected to the inversion controller.

The inversion controller is connected to the main control module.

In the first full-bridge circuit, two pins with a same output/input function are connected to the switch module, and the other two pins with a same output/input function are connected to two terminals of a second capacitor C2.

The two pins connected to the two terminals of the second capacitor C2 in the first full-bridge circuit are also connected to two pins of the third full-bridge circuit.

The third full-bridge circuit is composed of MOS transistors and their parasitic diodes, that is, Q2A, Q2B, Q2C and Q2D. Gates of the MOS transistors and their parasitic diodes, that is, Q2A, Q2B, Q2C and Q2D, are all connected to the step-down controller.

The step-down controller is connected to the main control module.

The other two pins of the third full-bridge circuit are connected to one terminal of the transformer T1, and the other terminal of the transformer T1 is connected to two pins of the second full-bridge circuit.

The second full-bridge circuit is composed of MOS transistors and their parasitic diodes, that is, Q1A, Q1B, Q1C and Q1D. Gates of the MOS transistors and their parasitic diodes, that is, Q1A, Q1B, Q1C and Q1D, are all connected to the step-up controller.

The step-up controller is connected to the main control module.

The other two pins of the third full-bridge circuit are connected to two terminals of a first capacitor C1 and are respectively connected to positive and negative terminals of the battery pack.

In a specific implementation mode of a preferred embodiment provided in the present disclosure, the mains supply is connected, a microcontroller unit (MCU) of the main control module receives the signal of the mains supply, and outputs the signal to turn off the inversion controller and the step-up controller, and turn on the switching switch and a step-down control circuit. The mains supply is shunted into two parts. One part is directly transmitted to the electrical appliance through the switching switch. The other part is converted into the high-voltage direct current after being rectified by the diodes on the Q3A to Q3D, and then a high-frequency pulse voltage is formed through the Q2A to Q2D, and then is stepped down by the transformer T1, rectified by the diodes on the Q1A to Q1D, and filtered by the C1 to form the low-voltage direct current to charge the battery pack. In this way, one part of the mains supply directly supplies power to the electrical appliance, and the other part of the mains supply is used to charge a battery after being rectified and stepped down, such that the battery pack is charged and the electrical appliance is powered at the same time. In addition, the mains supply is shunted to charge the battery pack and supply power to the electrical appliance, which does not affect operation of the electrical appliance or charging time of the battery pack.

The transformer, the capacitor, and the MOS transistor of the inversion circuit are shared, which is a principle of bidirectional charging of an energy storage product. This greatly reduces space occupied by components and can greatly improve a heat dissipation condition.

In this embodiment, the main control module is further configured to:
when the connected mains supply is not detected, control the switch module to turn on the circuit, such that electric energy output by the battery pack is transmitted to the electrical appliance after passing through the step-up and step-down switching module, the inversion and rectification module, and the switch module in turn;
control the step-up and step-down switching module to switch to a step-up function, so as to convert a low voltage output by the battery pack into a high voltage; and
control the inversion and rectification module to switch to an inversion function, so as to convert a direct current output by the battery pack into an alternating current.

In a specific implementation mode of a preferred embodiment, if the mains supply is disconnected, in other words, the MCU of the main control module does not detect the mains supply, a signal is output to turn on a step-up control circuit and the inversion controller and turn off the step-down controller. A voltage of the battery pack is converted into a high-frequency pulse voltage through the Q1A to Q1D, the high-frequency pulse voltage is coupled by the transformer T1, rectified by the diodes on the Q2A to Q2D in a bridge manner, and filtered by the C2 to form a high-voltage direct current, and then the high-voltage direct current is converted into an alternating current through the Q3A to Q3D to be used by the electrical appliance.

In this embodiment, the main control module is further configured to:

control the switch module to turn off the circuit to stop supplying power to the electrical appliance.

It can be understood that after the switch module is turned off, in other words, an inversion power switch is turned off, the main control module sends an instruction to turn off the step-up, step-down, and inversion control circuits. In this case, if there is no mains supply, the whole apparatus is turned off.

The present disclosure provides the bidirectional charging circuit, apparatus, and control method of an electricity storage device. In the circuit in the present disclosure, the step-up and step-down switching module supports switching between the step-up function and the step-down function. The step-up and step-down switching module switches to the step-up function, to increase an output voltage of the battery pack, and enable the battery pack to perform discharging outward by inverting the direct current into the alternating current by the inversion and rectification module, thereby realizing a discharging function. The step-up and step-down switching module switches to the step-down function, such that the alternating current input into the mains supply is converted into the direct current by the inversion and rectification module, and then an input voltage is stepped down to a voltage that meets a specification of the battery pack, thereby charging the battery pack. A charging current needs to pass through the inversion and rectification module before reaching the battery pack or a discharging current needs to pass through the inversion and rectification module before being output to the electrical appliance, in other words, the inversion and rectification module is shared for both a charging function and the discharging function. Therefore, compared with a solution in which the charging module and the discharging module are separately configured for a rectification circuit and an inversion circuit, the solutions in the present disclosure realize a bidirectional charging and discharging technology, and can effectively simplify the circuit, save space occupied by the charging module and the discharging module, and reduce a scale of the overall circuit.

In addition, according to the bidirectional charging control method of an electricity storage device, one part of the mains supply directly supplies power to the electrical appliance, and the other part of the mains supply is used to charge the battery after being rectified and stepped down, such that the battery pack is charged and the electrical appliance is powered at the same time. In addition, the mains supply is shunted to charge the battery pack and supply power to the electrical appliance, which does not affect the operation of the electrical appliance or the charging time of the battery pack.

What's more, the overall circuit in the present disclosure shares the transformer, the capacitor, and the MOS transistor, which can reduce DC-AC circuit space by 30% to 50%. An integration degree is high, which greatly reduces the space occupied by the components, greatly reduces a cost of a printed circuit board (PCB), improves a cost performance ratio of a product by 20% or above, greatly improves the heat dissipation condition, reduces an accident rate, and makes a high-voltage small-current scheme safer.

The descriptions above are preferred implementations of the present disclosure. It should be noted that for a person of ordinary skill in the art, various improvements and modifications can be made without departing from the principles of the present disclosure. These improvements and modifications should also be regarded as falling into the protection scope of the present disclosure.

1. A bidirectional charging circuit of an electricity storage device, comprising a step-up and step-down switching module, an inversion and rectification module, a switch module, and a main control module, wherein
the step-up and step-down switching module is provided with a battery connection terminal connected to a battery pack, the switch module is provided with a load connection terminal connected to an electrical appliance and a first mains supply connection terminal, and the main control module is provided with a second mains supply connection terminal;
the step-up and step-down switching module is connected to the inversion and rectification module, and the inversion and rectification module is connected to the switch module; and
the main control module is separately connected to the step-up and step-down switching module, the inversion and rectification module, and the switch module.

2. The bidirectional charging circuit of an electricity storage device according to claim 1, wherein the inversion and rectification module comprises an inversion controller and a first full-bridge circuit composed of a field effect transistor and its parasitic diode, and switch control terminals of field effect transistors of the first full-bridge circuit are all connected to the inversion controller.

3. The bidirectional charging circuit of an electricity storage device according to claim 2, wherein the step-up and step-down switching module comprises a step-up module, a step-down module, and a transformer;
the step-up module comprises a step-up controller and a second full-bridge circuit composed of a field effect transistor and its parasitic diode, and switch control terminals of field effect transistors of the second full-bridge circuit are all connected to the step-up controller;
the step-down module comprises a step-down controller and a third full-bridge circuit composed of a field effect transistor and its parasitic diode, and switch control terminals of field effect transistors of the third full-bridge circuit are all connected to the step-down controller; and
one terminal of the transformer is connected to the second full-bridge circuit, and the other terminal of the transformer is connected to the third full-bridge circuit.

4. The bidirectional charging circuit of an electricity storage device according to claim 3, wherein any of the first full-bridge circuit, the second full-bridge circuit, or the third full-bridge circuit comprises a first field effect transistor, a second field effect transistor, a third field effect transistor, and a fourth field effect transistor that are specifically connected in a following manner:
a drain of the first field effect transistor is connected to a drain of the second field effect transistor, and a source of the third field effect transistor is connected to a source of the fourth field effect transistor; and
a source of the first field effect transistor is connected to a drain of the third field effect transistor, and a source of the second field effect transistor is connected to a drain of the fourth field effect transistor.

5. The bidirectional charging circuit of an electricity storage device according to claim 4, wherein the first field effect transistor, the second field effect transistor, the third field effect transistor, and the fourth field effect transistor are all N-channel metal oxide semiconductor (MOS) transistors.

6. The bidirectional charging circuit of an electricity storage device according to claim 3, wherein the step-up and step-down switching module further comprises a capacitor for filtering, and the capacitor is connected in parallel to the second full-bridge circuit or the third full-bridge circuit.

7. A bidirectional charging apparatus of an electricity storage device, comprising a battery pack and the bidirectional charging circuit of an electricity storage device according to claim 1, wherein the battery pack is connected to a battery connection terminal of the bidirectional charging circuit of the electricity storage device.

8. A bidirectional charging control method of an electricity storage device, applied to the bidirectional charging circuit of an electricity storage device according to claim 1, wherein
the main control module is configured to:
when a connected mains supply is detected by the second mains supply connection terminal, control the switch module to turn on the circuit, such that the mains supply is connected to the electrical appliance by the load connection terminal and connected to the battery pack after passing through the switch module, the inversion and rectification module, and the step-up and step-down switching module in turn;
control the inversion and rectification module to switch to a rectification function, such that the mains supply is converted into a direct current after being rectified; and
control the step-up and step-down switching module to switch to a step-down function, so as to convert a high voltage of the mains supply into a low voltage.

9. The bidirectional charging control method of an electricity storage device according to claim 8, wherein the main control module is further configured to:
when the connected mains supply is not detected, control the switch module to turn on the circuit, such that electric energy output by the battery pack is transmitted to the electrical appliance after passing through the step-up and step-down switching module, the inversion and rectification module, and the switch module in turn;
control the step-up and step-down switching module to switch to a step-up function, so as to convert a low voltage output by the battery pack into a high voltage; and
control the inversion and rectification module to switch to an inversion function, so as to convert a direct current output by the battery pack into an alternating current.

10. The bidirectional charging control method of an electricity storage device according to claim 9, wherein the main control module is further configured to:
control the switch module to turn off the circuit to stop supplying power to the electrical appliance.

11. A bidirectional charging control method of an electricity storage device, applied to the bidirectional charging apparatus of an electricity storage device according to claim 7, wherein
the main control module is configured to:
when a connected mains supply is detected by the second mains supply connection terminal, control the switch module to turn on the circuit, such that the mains supply is connected to the electrical appliance by the load connection terminal and connected to the battery pack after passing through the switch module, the inversion and rectification module, and the step-up and step-down switching module in turn;
control the inversion and rectification module to switch to a rectification function, such that the mains supply is converted into a direct current after being rectified; and
control the step-up and step-down switching module to switch to a step-down function, so as to convert a high voltage of the mains supply into a low voltage.

12. The bidirectional charging control method of an electricity storage device according to claim 11, wherein the main control module is further configured to:
when the connected mains supply is not detected, control the switch module to turn on the circuit, such that electric energy output by the battery pack is transmitted to the electrical appliance after passing through the step-up and step-down switching module, the inversion and rectification module, and the switch module in turn;
control the step-up and step-down switching module to switch to a step-up function, so as to convert a low voltage output by the battery pack into a high voltage; and
control the inversion and rectification module to switch to an inversion function, so as to convert a direct current output by the battery pack into an alternating current.

13. The bidirectional charging control method of an electricity storage device according to claim 12, wherein the main control module is further configured to:
control the switch module to turn off the circuit to stop supplying power to the electrical appliance.
